(19) United States
(12) Patent Application Publication
(10) Pub. No.: US 2008/0159506 A1
(43) Pub. Date: Jul. 3, 2008

(54) NETWORK ELEMENT PROVISIONING AND EVENT SIMULATION IN A COMMUNICATIONS NETWORK

(75) Inventor: Raj Raheja, Roswell, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/617,384

(22) Filed: Dec. 28, 2006

(51) Int. Cl. H04M 3/42

(52) U.S. Cl. 379/201.12

(57) ABSTRACT

In a network management system, an application program simulates provisioning operations and other network events in a communications network. The network management system may receive a selection of live network elements to be utilized in a simulated provisioning operation and provisioning instructions. The network management system may then flag the selected live network elements as simulated network elements which may be logical representations of their physical counterparts. The network management system may then execute the provisioning instructions on the simulated network elements to simulate the provisioning of the live network elements. The network management may also receive a selection of live network elements and/or element management systems to be utilized in simulating network events. The network management system may then flag the selected live network elements and/or element management systems and generate the network events based on received event data.

### BACKGROUND

Telecommunications service providers offer and support a number of services for customers such as digital subscriber line (“DSL”) service utilized for Internet access. As the customer base telecommunications service providers continues to increase, providers must manage increasingly large numbers of network elements or devices utilized for providing these services in their networks. Accordingly, a network operations support system (“OSS”) utilized for handling service requests for maintenance and support activities is required to perform these tasks in larger and more diverse networks. Typical maintenance and support activities include network upgrades (which include adding new equipment to an existing network configuration) and equipment faults. As the size and diversity of networks increase, the OSS must continuously evaluate the handling of increasing volumes of service requests which may include requests for adding new services or modifying existing services, by undergoing large scale performance testing.

Currently, large scale performance testing is done using a combination of physical test bed and simulators so that customer data traffic is not affected. A simulator may be essentially a replica of a service provider's hardware inventory which must be configured so that it is analogous to the “live” network. Large scale performance testing using a physical test bed, however, suffers from a number of drawbacks. One drawback is that the same volume and type of hardware that exists in a provider's network must be purchased and utilized in order to simulate live network conditions. Since a single piece of hardware may cost on the order of tens or even hundreds of thousands of dollars, large service providers may spend millions of dollars on hardware to populate a test bed as well as the additional costs required to install and maintain the hardware. Another drawback is that typical service providers utilize hardware manufactured by a variety of vendors in a single network configuration and although one vendor's hardware may perform the same task as another vendor's hardware, the two types of hardware may have different configuration requirements for operating in the network. As a result, service providers lose additional man hours in labor in configuring test bed hardware manufactured by different vendors which may ultimately result in a delay in offering new services or technologies to network customers. A drawback with current simulators is that they are limited to local event testing making it impractical to simulate large network events such as event storms which may be caused by a cable cut. Still another drawback with current simulators is that they require the hardware test bed to perform any testing. Thus, it is not possible to perform network provisioning in advance of having the associated hardware which may which may ultimately result in a delay in fulfilling new service orders to network customers while awaiting delivery and installation of the necessary hardware. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Various embodiments utilizing the techniques described herein address the above and other problems by providing an application program executing on a network management system (“NMS”) to simulate provisioning and other network events on live network elements and element management systems in a communications network. In accordance with some exemplary embodiments, an NMS may receive a selection of live network elements to be utilized in a simulated provisioning operation, and instructions for provisioning the selected live network elements. The live network elements may be utilized to provide a network service such as digital subscriber line (“DSL”). The NMS may then flag the selected live network elements as simulated network elements which may be software-based logical representations of their physical counterparts. The NMS may then execute the provisioning instructions on the simulated network elements to simulate the provisioning of the live network elements.

In accordance with other exemplary embodiments, an NMS may receive a selection of live network elements and/or element management systems (“EMS”) to be utilized in simulating network events and receive event data defining the network events to be simulated, such as an event storm. The NMS may then flag the selected live network elements and/or EMS as simulated and generate the network events on the simulated network elements and/or EMS based on the received event data.

Other systems, methods, and/or computer program products according to various embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a network architecture diagram illustrating aspects of an exemplary communications network utilized in and provided by various embodiments of the invention;

FIG. 2 is a flow diagram illustrating aspects of a process for simulating the provisioning of one or more live network elements in communication with a network management system (“NMS”), utilizing the network architecture of FIG. 1, in accordance with various embodiments of the invention; and

FIG. 3 is a flow diagram illustrating aspects of a process for simulating network events involving one or more live network elements or element management systems (“EMS”) in communication with an NMS, utilizing the network architecture of FIG. 1, in accordance with various embodiments of the invention.

### DETAILED DESCRIPTION

As briefly described above, embodiments of the present invention are directed to providing an application program executing on a network management system (“NMS”) to simulate provisioning and other network events on live network elements and element management systems in a communications network. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

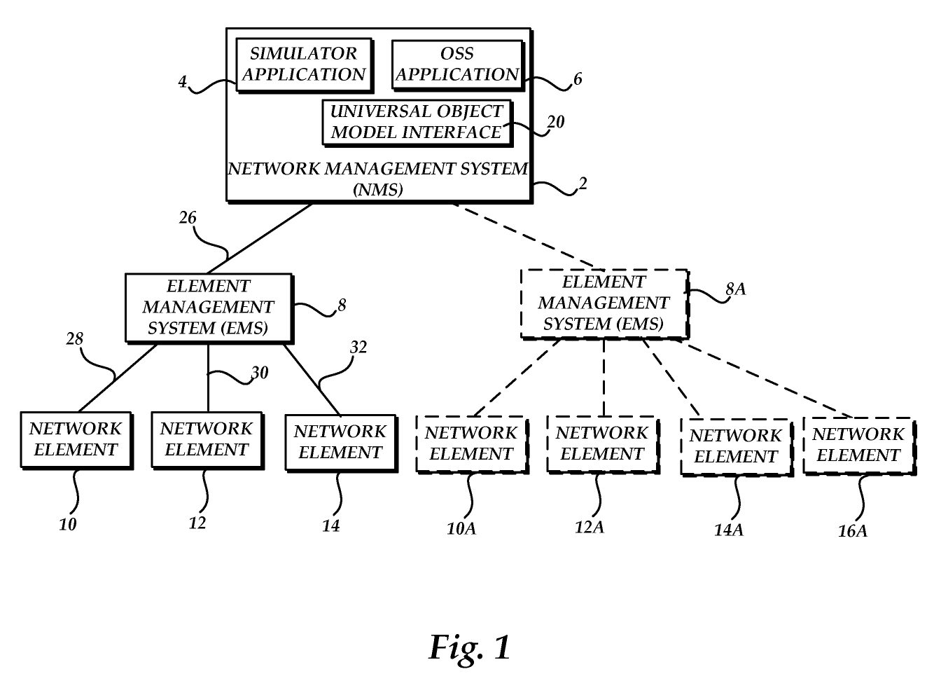

Referring now to the drawings, in which like numerals represent like elements through the several figures, various aspects of the present invention and an illustrative computing operating environment will be described. In particular, FIG. 1 and the corresponding discussion are intended to provide a brief, general description of a suitable computing environment in which the invention may be implemented. While the invention will be described in the general context of program modules that execute in conjunction with an application program that runs on a computing device, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process, a computing system, or as an article of manufacture, such as a computer program product or computer-readable media. The computer program product may be a computer storage media readable by a computer system and encoding a computer program of instructions for executing a computer process. The computer program may also be a propagated signal on a carrier readable by a computing system and encoding a computer program of instructions for executing a computer process.

Referring now to FIG. 1, an exemplary network architecture for the several embodiments utilizing the techniques described herein, will be described. As shown in FIG. 1, a network management system (“NMS”) 2 communicates with a live element management system (“EMS”) 8 through a telecommunication pathway 26. It should be understood that telecommunication pathway 26 and others shown here and through this description may be any common type of electronic communication medium, unless otherwise indicated.

A given NMS, such as the NMS 2, may be, for example, a network operations support system used by a telecommunications company for managing service provisioning in the telecommunication network and may have hundreds of EMS, such as the EMS 8, connected to it. In accordance with various embodiments utilizing the technical features described herein, the NMS 2 may be a part of a digital subscriber line (“DSL”) network operated by, for example, a telephone or telecommunications company. The EMS 8 has control of network elements 10, 12, and 14, which may be for example telecommunications switches, through telecommunication pathways 28, 30, and 32. It should be understood that the NMS 2, the EMS 8, and the network elements 10, 12, and 14 may comprise or be in communication with any of a number of communications networks known to those skilled in the art including, but not limited to, an asynchronous transfer mode (“ATM”) network, an Internet protocol (“IP”) network, a Mulitprotocol Label Switching (“MPLS”) network, a wireless network, and a voice over IP (“VOIP”) network, among others. It should be understood that, in accordance with various exemplary embodiments, the network described herein may be heterogeneous with respect to hardware such as the EMS 8 and the individual network elements 10, 12, and 14. That is, each piece of hardware utilized in the network may be manufactured by a different vendor, have different timing requirements with respect to various provisioning steps associated with “turning up” the hardware, etc.

The NMS 2 may comprise an operational support system (“OSS”) application program (or programs) 6 for monitoring, analyzing, and managing a communications network, executing on a networked computer. The OSS application 6 may be utilized by a user to evaluate the condition of downstream network elements 10, 12, and 14 through the use of the EMS 8 during provisioning operations and during network events involving the network elements. For instance, to evaluate the condition of the network element 10, a user may utilize the NMS 2 to send a signal that is transmitted along communication pathway 26 to the EMS 8, and along communication pathway 28 to the network element 10 for a current operational status. If the network element 10 is not operating properly, the return signal (such as an alarm signal) from the network element 10 back to the NMS 2 may indicate a malfunction caused by a network event (such as card failure).

The NMS 2 may also be operable to execute simulator application 4. The simulator application 4 may be utilized to simulate the operation of an inventory of “live” or physical hardware in a network architecture, including the EMS 8, network elements 10, 12, and 14, as well as their associated hardware components (e.g., hardware cards utilized for operating the equipment), on software-based logical representations of the physical hardware which are shown as an EMS 8A and network elements 10A, 12A, and 14A. In particular, the simulator application 4 may be utilized by the NMS 2 to simulate provisioning and other network events on live network elements and element management systems in a communications network.

In accordance with various embodiments utilizing the techniques described herein, among others, the simulator application 4 may access a universal object model interface 20 which is a software application programmed to logically represent network hardware such as the EMS 8A and the network elements 10A, 12A, and 14A. It should be understood that the universal object model interface 20 may also include logical representations of additional hardware without an associated “live” or physical counterpart, such as network element 16A. It should further be understood that according to various exemplary embodiments, the universal object model interface 20 may be “vendor neutral.” That is, the universal object model interface 20 may be programmed to represent various EMS and network elements from different vendors, including specific vendor operation requirements (such as timing settings, provisioning steps, etc.). It will be appreciated that the additional representations may be utilized by the simulator application 4 to simulate load testing on an existing architecture after adding a new network element. As should be understood by those skilled in the art, the universal object model interface 20 may be based on a number of known interface specifications including, but not limited to, Telecommunications Management Network (“TMN”), Operations Support System through Java (“OSS/J”), and TeleManagement™ Forum Interface Implementation Specification 814 (“TMF814”), among others.

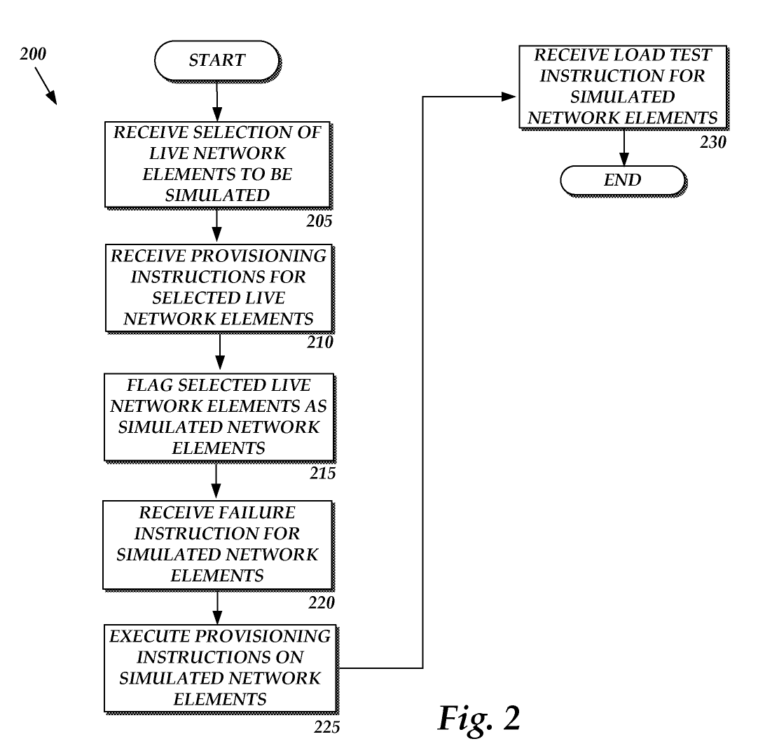

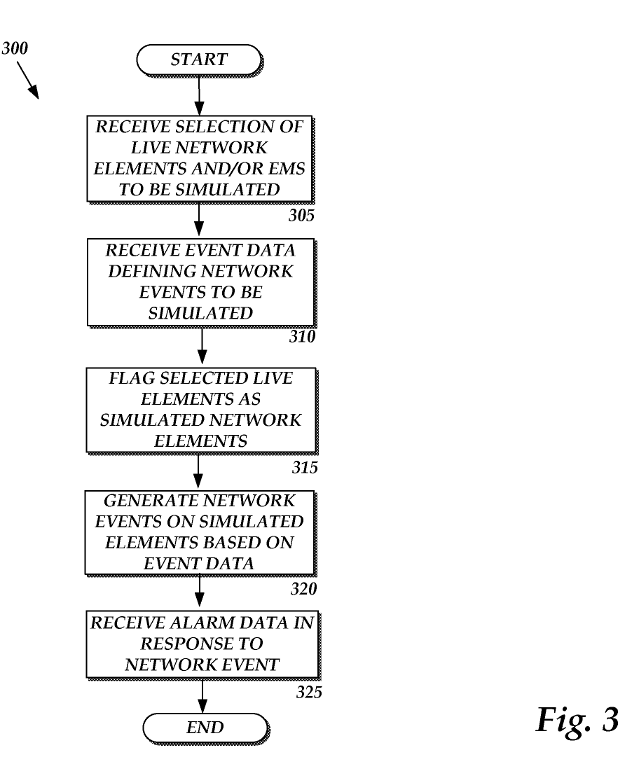

It should be understood that in accordance with alternative embodiments, the vendor associated data for live network hardware, such as the EMS 8 and the network elements 10, 12, and 14, may be entered directly into the NMS 2 by a user and utilized by the simulation application 4 to “model” the operation and provisioning of the live network hardware. The operation of the simulator application 4 will be discussed in greater detail below with respect to FIGS. 2-3.

Referring now to FIG. 2, an illustrative routine 200 will be described illustrating a process performed by the simulator application 4 executing on the NMS 2 for simulating the provisioning of one or more live network elements in an electronic architecture configuration for providing a network service in a communications network. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIGS. 2-3, and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

The routine 200 begins at operation 205, where the simulator application 4 receives a selection of live network elements to be simulated. In particular, a user of the simulator application 4 may select the network elements 10, 12, and 14 for simulating a provisioning operation such as may be required when moving from one network platform (such as ATM) to a different network platform (such as IP).

From operation 205, the routine 200 continues to operation 210, where the simulator application 4 receives provisioning instructions for the selected live network elements. In particular, the simulator application 4 may receive instructions from a user to execute the steps necessary to provision the network elements 10, 12, and 14 for operation in an IP network.

From operation 210, the routine 200 continues to operation 215, where the simulation application 4 flags the selected live network elements as simulated network elements. In particular, the simulation application 4 may instruct the NMS 2 to “toggle” from the network elements 10, 12, and 14 to the simulated network elements 10A, 12A, and 14A prior to executing any provisioning instructions or commands. It should be understood by those skilled in the art that the flagging of the selected live network elements may include a software flag which, when set, signals the toggle to the simulated network elements 10A, 12A, and 14A. That is, when the flag is set, the NMS 2 will treat the physically attached live hardware as simulated hardware. It will be appreciated that the simulated network elements 10A, 12A, and 14A may be accessed via the universal object model interface 20 which includes various parameters associated with the operation of their live hardware counterparts including, but not limited to, shelf data (e.g., shelf identification and location information), card data (e.g., card identification and location information), port data (e.g., for one or more ports in the network element), channel data (e.g., data for one or more communications channels for communicating data to and from the network element), and quality of service data.

From operation 215, the routine 200 continues to operation 220, where the simulator application 4 receives a failure instruction for one or more of the simulated network elements to be executed during the simulated provisioning operation. In particular, a user may instruct the simulator application 4 to instruct the NMS 2 to fail at a specified step in the provisioning of a particular network element. For instance, a user may instruct the network element 10A requiring ten provisioning steps to fail on the sixth step to determine the effect on the network.

From operation 220, the routine 200 continues to operation 225, where a user of the simulator application 4 instructs the NMS 2 to execute the received provisioning instructions on the simulated network elements. In particular, the execution of the received provisioning instructions on the simulated network elements may simulate the provisioning of the live network elements. For instance, a user of the simulator application 4 may instruct the NMS 2 to execute the provisioning instructions on the simulated network elements 10A, 12A, and 14A within a predetermined time interval to determine how the network will react. In accordance with various embodiments, among others, the provisioning instructions may be executed via the object model interface 20 which interprets and applies the instructions in compliance with various timing requirements which may be associated with different vendor manufacturers of the live network elements (such as the number of seconds required for each provisioning step per vendor). It will be appreciated that in this manner, the user of the simulator application 4 is not required to retrieve and input this information into the NMS 2 prior to executing the provisioning instructions.

From operation 225, the routine 200 continues to operation 230, where the simulator application 4 receives a load test instruction for the simulated network elements. In particular, the simulator application 4 may instruct the NMS 2 to perform a load test on the simulated network elements after having been “provisioned” to determine the effect that the operation of the newly provisioned network elements will have on the network. It should be appreciated that the load testing of the simulated network elements enables simulated load testing of live network elements without using a physical test bed. From operation 230, the routine 200 then ends. It should be appreciated that the use of the simulator application 4, in accordance with various embodiments, may serve to reduce the time to market for provisioning new network services as the NMS can develop service provisioning at the same time as an equipment vendor is developing the necessary hardware to support new services.

Referring now to FIG. 3, an illustrative routine 300 will be described illustrating a process performed by the simulator application 4 executing on the NMS 2 for simulating network events involving live network elements and EMS in an electronic architecture configuration for providing a network service in a communications network. The routine 300 begins at operation 305, where the simulator application 4 receives a selection of live network elements or EMS to be simulated. For instance, a user of the simulator application 4 may select the network element 10 and/or the EMS 8 to be used in an event simulation such as an event storm. As known to those skilled in the art, an event storm may occur when a communications network generates large numbers of events or alarms from multiple network elements as a result of a single incident such as when a trunk cable is cut. An event storm may comprise several hundred events per second for tens of seconds resulting in an overload of information, thus making it difficult to identify a particular incident or where the incident occurred.

From operation 305, the routine 300 continues to operation 310 where the simulator application 4 receives event data defining one or more network events to be simulated. The event data may include instructions for generating a specified number of alarms and failures (such as a card failure) in the selected network elements and/or EMS. The event data may also include instructions for generating a communication loss between one or more selected network elements and an EMS. For instance, the event data may include instructions to generate a large number of alarms in each of the network elements 10, 12, and 14 as well as in the EMS 8 to simulate an event storm.

From operation 310, the routine 300 continues to operation 315 where the simulation application 4 flags the selected live network elements and/or EMS as simulated elements. In particular, the simulation application 4 may instruct the NMS 2 to “toggle” from the network elements 10, 12, and 14 to the simulated network elements 10A, 12A, and 14A and from the EMS 8 to the simulated EMS 8A, prior to generating any network events. Similar to the description of operation 215 in the discussion of FIG. 2 above, when the flag is set, the NMS 2 will treat the physically attached live hardware as simulated hardware with the various operating parameters (e.g., shelf data, card data, port data, channel data, and quality of service data being provided, in accordance with some embodiments, by the universal object model interface 20.

From operation 315, the routine 300 continues to operation 320 where the simulation application 4 generates network events on the simulated elements based on the event data. In particular, the simulation application 4 may instruct the NMS 2 to execute the instructions comprising the event data as discussed above in operation 310.

From operation 320, the routine 300 continues to operation 325 where the simulator application 4 receives alarm data from the simulated elements (i.e., the simulated network elements and/or the simulated EMS) so that a user may determine how the NMS 2 will react to receiving a specified number of alarms, for example. From operation 325, the routine 300 then ends.

Based on the foregoing, it should be appreciated that various embodiments of the present invention are directed to providing an application program executing on an NMS to simulate provisioning and other network events on live network elements and element management systems in a communications network. It will be apparent by those skilled in the art that various modifications or variations may be made in the present invention without departing from the scope or spirit of the invention. Other embodiments of the present invention will be apparent to those skilled in the art from consideration of the specification and practice of the invention disclosed herein.

I claim:

1. A computer-implemented method for simulating the provisioning of one or more live network elements in communication with a network management system (NMS) in an electronic architecture configuration for providing a network service in a communications network, comprising:
receiving, in the NMS, a selection of the one or more live network elements to be utilized in a simulated provisioning operation;
receiving, in the NMS, at least one instruction to provision the selected one or more live network elements for providing the network service;
flagging, in the NMS, the selected one or more live network elements in the electronic architecture configuration as one or more simulated network elements; and
executing the at least one provisioning instruction on the one or more simulated network elements to simulate the provisioning of the one or more live network elements in the electronic architecture configuration.

2. The method of claim 1, wherein executing the at least one provisioning instruction on the one or more simulated network elements to simulate the provisioning of the one or more live network elements in the electronic architecture configuration comprises executing the at least one provisioning instruction on the one or more simulated network elements within a predetermined time interval.

3. The method of claim 1, wherein executing the at least one provisioning instruction on the one or more simulated network elements to simulate the provisioning of the one or more live network elements in the electronic architecture configuration comprises executing a plurality of steps on the one or more simulated network elements.

4. The method of claim 3 further comprising receiving an instruction in the NMS to cause a failure in the one or more simulated network elements at a specified one of the plurality of steps during the simulated provisioning of the one or more live network elements.

5. The method of claim 1 further comprising receiving an instruction in the NMS to perform a load test on the one or more simulated network elements after the execution of the at least one provisioning instruction.

6. The method of claim 1, wherein flagging the selected one or more live network elements in the electronic architecture configuration as one or more simulated network elements comprises accessing an interface in communication with the NMS, the interface comprising a universal object model comprising a logical representation of a plurality of the live network elements, the logical representation comprising at least one of shelf data, card data, port data, channel data, and quality of service data associated with the operation of each of the plurality of live network elements, wherein each of the plurality of live network elements is associated with a different vendor.

7. A computer-implemented method for simulating network events involving one or more live network elements in communication with a network management system (NMS) in an electronic architecture configuration for providing a network service in a communications network, comprising:
receiving, in the NMS, a selection of the one or more live network elements to be utilized in simulating the at least one network event;
receiving, in the NMS, event data defining the at least one network event to be simulated;
flagging, in the NMS, the selected one or more live network elements in the electronic architecture configuration as one or more simulated network elements; and
generating the at least one network event on the one or more simulated network elements based on the received event data.

8. The method of claim 7 further comprising:
receiving, in the NMS, a selection of at least one live element management system (EMS) to be utilized in simulating the at least one network event;
flagging, in the NMS, the selected at least one live EMS as at least one simulated EMS; and
generating the at least one network event on the at least one simulated EMS based on the received event data.

9. The method of claim 8, wherein receiving, in the NMS, event data defining the at least one network event to be simulated comprises receiving at least one instruction, the at least one instruction comprising: an instruction to generate a plurality of alarms in the selected one or more live network elements, an instruction to generate one or more alarms generated in the selected at least one EMS, an instruction to generate a failure of the selected one or more live network elements, an instruction to generate a card failure in the one or more live network elements, and an instruction to generate a communication loss between the selected one or more live network elements and the selected at least one EMS.

10. The method of claim 9, wherein generating the at least one network event on the one or more simulated network elements based on the received event data comprises executing the at least one instruction on the one or more simulated network elements and generating the at least one network event on the at least one simulated EMS based on the received event data comprises executing the at least one instruction on the at least one simulated EMS.

11. The method of claim 7, wherein flagging the selected one or more live network elements in the electronic architecture configuration as one or more simulated network elements comprises accessing an interface in communication with the NMS, the interface comprising a universal object model comprising a logical representation of a plurality of the live network elements, the logical representation comprising at least one of shelf data, card data, port data, channel data, and quality of service data associated with the operation of each of the plurality of live network elements, wherein each of the plurality of live network elements is associated with a different vendor.

12. The method of claim 8, wherein flagging the selected at least one live EMS as at least one simulated EMS comprises accessing an interface in communication with the NMS, the interface comprising a universal object model comprising a logical representation of a plurality of EMS.

13. The method of claim 7 further comprising receiving a plurality of alarms generated by the one or more simulated network elements in response to the at least one network event, wherein the at least one network event comprises an event storm.

14. A computer-readable medium containing computer-executable instructions, which, when executed on a computer, will cause the computer to perform a method for simulating the provisioning of one or more live network elements in communication with a network management system (NMS) in an electronic architecture configuration for providing a network service in a communications network, the method comprising:
receiving, in the NMS, a selection of the one or more live network elements to be utilized in a simulated provisioning operation;
receiving, in the NMS, at least one instruction to provision the selected one or more live network elements for providing the network service;
flagging, in the NMS, the selected one or more live network elements in the electronic architecture configuration as one or more simulated network elements;
executing the at least one provisioning instruction on the one or more simulated network elements to simulate the provisioning of the one or more live network elements in the electronic architecture configuration; and
receiving an instruction in the NMS to perform a load test on the one or more simulated network elements after the execution of the at least one provisioning instruction.

15. The computer-readable medium of claim 14, wherein executing the at least one provisioning instruction on the one or more simulated network elements to simulate the provisioning of the one or more live network elements in the electronic architecture configuration comprises executing a plurality of steps on the more or more simulated network elements.

16. The computer-readable medium of claim 15 further comprising receiving an instruction in the NMS to cause a failure in the one or more simulated network elements at a specified one of the plurality of steps during the simulated provisioning of the one or more live network elements.

17. The computer-readable medium of claim 14, wherein flagging the selected one or more live network elements in the electronic architecture configuration as one or more simulated network elements comprises accessing an interface in communication with the NMS, the interface comprising a universal object model comprising a logical representation of a plurality of the live network elements, the logical representation comprising at least one of shelf data, card data, port data, channel data, and quality of service data associated with the operation of each of the plurality of live network elements, wherein each of the plurality of live network elements is associated with a different vendor.

18. A computer-readable medium containing computer-executable instructions, which, when executed on a computer, will cause the computer to perform a method for simulating network events involving one or more live network elements in communication with a network management system (NMS) in an electronic architecture configuration for providing a network service in a communications network, comprising:
receiving, in the NMS, a selection of the one or more live network elements to be utilized in simulating the at least one network event;
receiving, in the NMS, event data defining the at least one network event to be simulated;
flagging, in the NMS, the selected one or more live network elements in the electronic architecture configuration as one or more simulated network elements;
generating the at least one network event on the one or more simulated network elements based on the received event data; and
receiving a plurality of alarms generated by the one or more simulated network elements in response to the at least one network event, wherein the at least one network event comprises an event storm.

19. The computer-readable medium of claim 18, wherein receiving, in the NMS, event data defining the at least one network event to be simulated comprises receiving at least one instruction, the at least one instruction comprising: an instruction to generate a plurality of alarms in the selected one or more live network elements, an instruction to generate a failure of the selected one or more live network elements, an instruction to generate a card failure in the one or more live network elements, and an instruction to generate a communication loss in the selected one or more live network elements

20. The computer-readable medium of claim 18, wherein flagging the selected one or more live network elements in the electronic architecture configuration as one or more simulated network elements comprises accessing an interface in communication with the NMS, the interface comprising a universal object model comprising a logical representation of a plurality of the live network elements, the logical representation comprising at least one of shelf data, card data, port data, channel data, and quality of service data associated with the operation of each of the plurality of live network elements, wherein each of the plurality of live network elements is associated with a different vendor.
